(19) United States
(12) Patent Application Publication
(10) Pub. No.: US 2009/0027380 A1
(43) Pub. Date: Jan. 29, 2009

(54) 3-D visualization

(76) Inventors: Vivek Rajan, Houston, TX (US); Dennis Eric Adams, Katy, TX (US)

Correspondence Address: ARNOLD & KNOBLOCH, L.L.P., 2401 FOUNTAIN VIEW DRIVE, SUITE 630, HOUSTON, TX, 77057, US

(21) Appl. No.: 11/880,553

(22) Filed: Jul. 23, 2007

(51) Int. Cl. G06T 15/00

(52) U.S. Cl. 345/419

(57) ABSTRACT

An apparatus, computer program, method, system, and graphical display are provided for analyzing and imaging 3-D or multi-dimensional data volumes using linked 2-D parametric surfaces. At least two 2-D parametric surfaces are each derived from a multi-dimensional data volume. The 2-D parametric surfaces are displayed. The 2-D parametric surfaces are linked to each other. A user interface enables rotation, translation, or scaling of the planes. The linked planes are operated upon in unison. The 2-D parametric surfaces are redisplayed. A subset area may be defined to restrain the area of additional computations.

### FIELD OF THE INVENTION

The present invention relates to enhanced visualization of 3-D or multi-dimensional data volumes. More particularly, the present invention relates to enhanced visualization and identification of features contained within a multidimensional data volume.

### BACKGROUND TO THE INVENTION

The visibility of geologic and/or topographic features in a 3-D data volume depends greatly on the viewing angle of perspective of the subject feature. A steep or faulted structure is most visible in its “dip” direction versus its perpendicular “strike” direction. The dip or strike direction of a feature may not be aligned to the axes of a 3-D data volume and furthermore may change along the lateral extent of the feature. Current practice renders it difficult to orient the viewed portions of a 3-D data volume so as to align and track the dip and strike viewing perspectives. This renders the user further limited in ability to focus on identification and tracking of features across various combinations of angles of perspective within the data volume.

Data volumes typically contain one or more volumes of attribute values associated with a collection of spatial and/or temporally located positions. For example, a data volume may contain a set of data values with information to place each of the data values at some x,y,z location in space. Typically, in petroleum exploration, the data values may represent various observed or calculated geological or geophysical properties, such as seismic amplitude, velocity, impedance, sand-shale ratio, or a host of other “attributes”. For example, in medical imaging an attribute may be X-Ray contrast. Attributes may be scalar data values, multidimensional data values or structures, vectors, or matrices. For example, the seismic amplitude at various offsets in a common-depth-point seismic-gather is an attribute having a multidimensional array of data values.

Use of computers with advanced graphics capabilities for the visualization of data contained within 3-D data volumes is known and incorporated herein by reference. Typically, individual planes of data are displayed from a 3-D data volume for further analysis. These planes may be rotated or scaled to enhance ease in visualization of features contained within the 3-D data volume. 3-D sub-volumes may also be extracted from a 3-D data volume for further analysis of either the remaining 3-D volume and/or the extracted subset volume. These techniques are limited by the continued handling and/or display of 3-D data volumes, either through continued display of a portion of the 3-D data volume and/or one or more subset data volumes. This causes a number of problems.

For example, when a user attempted to identify and/or track a feature within the data volume, with visualization techniques in the past, the user had to maintain its orientation within the data volume by constantly comprehending and observing the intersection of various 3-D volumes and subset volumes. To maintain the user's orientation, much data is displayed on a graphics-enabled computing device that is not pertinent to identifying and tracking the feature(s) of interest. In one specific example, Cheung et al., U.S. Pat. No. 6,765,570 B1, to provide the user with graphic orientation within a 3-D data volume that is intersected by a subset 3-D data volume, the user is presented with several faces of an original data volume and a subset 3-D data volume. Much of these displayed faces contain little or no information related to the feature being sought for identification or tracking, but is thought to be needed to allow the user to be oriented within the 3-D data volume. There is a premium on the user's limited capacity to assimilate the massive amount of information contained in many multidimensional data volumes. This capacity is overwhelmed by such a visualization technique.

### SUMMARY OF EXAMPLES OF THE INVENTION

The following examples dispense with the need to produce 3-D volume subsets and the need to display such subsets along with portions of the original 3-D data volume in order to maintain a user's viewing orientation within the data volume, although the invention is not limited to systems and processes that make no such production or display. In at least one example, the user is presented with selected slices extracted from a 3-D data volume, which will be, in at least one example, translated or rotated in unison. Therefore, the user is provided with an enhanced ability to visualize, identify, and track features of interest. Further, more specific examples provide additional display of the pertinent areas of interest surrounding the feature while avoiding the need to display non-pertinent portions of a data volume.

According to a first set of examples of the invention, a program storage device readable by a machine is provided, tangibly embodying a program of instructions executable by the machine to perform steps of displaying at least one multi-dimensional data volume, the steps including: creating a plurality of 2-D parametric surfaces, wherein each 2-D parametric surface is derived from the at least one data volume; drawing at least a portion of each 2-D parametric surface for display to a user; linking at least two of the plurality of 2-D parametric surfaces to each other; performing an operation on the linked at least two of the plurality of 2-D parametric surfaces while maintaining the relative orientation of the at least two of the plurality of 2-D parametric surfaces with respect to each other; and repeating the drawing step.

In a further example, the performing-an-operation step includes an operation selected from a group including: translation, rotation, and scaling.

In a further example, the steps further include the steps of: creating a first set of control points on at least one of the plurality of 2-D parametric surfaces; repeating the performing-an-operation step; repeating the drawing step; creating a second set of control points on at least one of the plurality of 2-D parametric surfaces; and deriving a surface from the first set of control points and the second set of control points.

In a further example, the steps include the steps of: identifying a feature on at least one of the plurality of 2-D parametric surfaces; and the performing-an-operation step is operable to place at least one of the plurality of 2-D parametric surfaces so as to change the obliqueness of the placed 2-D parametric surfaces with respect to the apparent plane of the feature.

In a further example, at least a first 2-D parametric surface of the plurality of 2-D parametric surfaces is derived from an attribute of the data volume and at least a second 2-D parametric surface of the plurality of 2-D parametric surfaces is derived from a different attribute of the data volume.

In a further example, at least a first 2-D parametric surface of the plurality of 2-D parametric surfaces is derived from an attribute of a first data volume and at least a second 2-D parametric surface of the plurality of 2-D parametric surfaces is derived from an attribute of a second data volume.

In a further example, defining a multidimensional area of interest is performed, whereby an area for restraining computations will be, in at least one example, formed.

In at least one example, the 2-D parametric surfaces consist essentially of planar surfaces having no thickness.

In some examples, the 2-D parametric surfaces consist essentially of curved 2-D parametric surfaces having no thickness.

In a further example, the 2-D parametric surfaces consist essentially of defined surfaces having no thickness.

In a further example, the combination of the operation step and the drawing step is performed in less than one-tenth of a second.

In a further example, the at least one multi-dimensional data volume includes geoscientific data.

In a further example, the at least one multi-dimensional data volume includes petroleum reservoir data.

In a further example, the multi-dimensional data volume includes 3D seismic data, where the multi-dimensional data volume further includes at least one attribute. In a further example, at least one attribute is seismic amplitude.

In a further example, at least one multi-dimensional data volume includes at least one attribute.

In a further example, the linked at least two of the plurality of 2-D parametric surfaces form an open surface.

In a further example, the linking of the at least two of the plurality of 2-D parametric surfaces is releasable.

According to a second set of examples of the invention, a method for visualization of a multi-dimensional data volume is provided, representing a spatial zone for visualization and interpretation of physical parameters of the spatial zone selected by a user, the multi-dimensional volume being defined by one or more attributes and information leading to the placement of the attributes in the spatial zone, the method including: creating a plurality of 2-D parametric surfaces, where each 2-D parametric surface is derived from the data volume; drawing at least a portion of an image of each 2-D parametric surface for display to a user; linking at least two of the plurality of 2-D parametric surfaces to each other; performing an operation on the linked at least two of the plurality of 2-D parametric surfaces while maintaining the relative orientation of the at least two of the plurality of 2-D parametric surfaces with respect to each other; and repeating the drawing step.

In a further example, the performing-an-operation includes an operation selected from a group including: translation, rotation, and scaling.

In a further example, the method further includes the steps of: creating a first set of control points on at least one of the plurality of 2-D parametric surfaces; repeating the performing-an-operation step; repeating the drawing step; creating a second set of control points on at least one of the plurality of 2-D parametric surfaces; and fitting a surface from the first set of control points and the second set of control points.

In a further example, the method further includes the steps of: identifying a feature on at least one of the plurality of 2-D parametric surfaces; and the performing-an-operation step includes placing at least one of the plurality of 2-D parametric surfaces so as to change the obliqueness of the placed at least one of the plurality of 2-D parametric surfaces with respect to the apparent plane of the feature.

In a further example, at least a first 2-D parametric surface of the plurality of 2-D parametric surfaces is derived from a first attribute of the data volume and at least a second 2-D parametric surface of the plurality of 2-D parametric surfaces is derived from a second attribute of the data volume.

In a further example, at least a first 2-D parametric surface of the plurality of 2-D parametric surfaces is derived from an attribute of a first data volume and at least a second 2-D parametric surface of the plurality of 2-D parametric surfaces is derived from an attribute of a second data volume.

In a further example, the method further includes the step of defining a multidimensional area of interest, whereby an area for restraining computations is formed.

In a further example, the step of creating a plurality of 2-D parametric surfaces further comprises the step of creating one or more 2-D parametric surfaces consisting essentially of planar surfaces having no thickness.

In a further example, the step of creating a plurality of 2-D parametric surfaces further comprises the step of creating one or more 2-D parametric surfaces consisting essentially of curved 2-D parametric surfaces having no thickness.

In a further example, the step of creating a plurality of 2-D parametric surfaces further comprises the step of creating one or more 2-D parametric surfaces consisting essentially of defined surfaces having no thickness.

In a further example, the combination of the operation step and the drawing step is performed in less than one-tenth of a second.

In a further example, the multi-dimensional data volume includes geoscientific data.

In a further example, the multi-dimensional data volume includes petroleum reservoir data.

In a further example, the multi-dimensional data volume includes 3D seismic data, and the multi-dimensional data volume further includes at least one attribute. In a further example, at least one attribute is seismic amplitude.

In a further example, the multi-dimensional data volume includes at least one attribute.

In a further example, the linked at least two of the plurality of 2-D parametric surfaces form an open surface.

In a further example, the linking of the at least two of the plurality of 2-D parametric surfaces is releasable.

According to a third set of examples of the invention, a computer program product is provided, which includes a computer useable medium having computer program logic recorded thereon for enabling a processor in a computer system to image a multi-dimensional data volume for visualization and interpretation of features selected by a user, where the multi-dimensional data volume is defined by one or more attributes and information leading to the placement of the attributes in a spatial zone, the computer program logic including: code to enable the processor to create a plurality of 2-D parametric surfaces where each 2-D parametric surface is derived from the data volume; code to enable the processor to draw at least a portion of each 2-D parametric surface for display to a user; code to enable the processor to link at least two of the plurality of 2-D parametric surfaces to each other; code to enable the processor to operate on the linked 2-D parametric surfaces while maintaining the relative orientation of the 2-D parametric surfaces with respect to each other; and code to enable the processor to repeat the drawing of at least a portion of each 2-D parametric surface for display to a user after occurrence of an operation on the linked 2-D parametric surfaces.

In a further example, the code to enable the processor to operate on the linked 2-D parametric surfaces includes code to enable the processor to perform an operation selected from a group of operations including: translation, rotation, and scaling.

In a further example, the computer program product further includes: code to enable the processor to create a first set of control points on at least one of the plurality of 2-D parametric surfaces; code to enable the processor to create a second set of control points on at least one of the plurality of 2-D parametric surfaces; and code to enable the processor to derive a surface from the first set of control points and the second set of control points.

In a further example, the code to enable the processor to operate on the linked 2-D parametric surfaces further includes: code to enable the processor to place at least one of the plurality of 2-D parametric surfaces so as to change the obliqueness of the placed at least one of said plurality of 2-D parametric surfaces with respect to the apparent plane of a feature.

In a further example, the data volume includes at least two attributes and further includes code to derive at least a first 2-D parametric surface of the plurality of 2-D parametric surfaces from a first attribute of the data volume and further includes code to derive at least a second 2-D parametric surface of the plurality of 2-D parametric surfaces from a second attribute of the data volume.

In a further example, the computer program product further includes: code to derive at least a first 2-D parametric surface of the plurality of 2-D parametric surfaces from an attribute of a first data volume and further includes code to derive at least a second 2-D parametric surface of the plurality of 2-D parametric surfaces from an attribute of a second data volume.

In a further example, the computer program logic further includes code to restrain computations within a multidimensional area of interest.

In a further example, the code to enable the processor to create one or more 2-D parametric surfaces further includes code to create a plurality of 2-D parametric surfaces that are planar surfaces having no thickness.

In a further example, the code to enable the processor to create one or more 2-D parametric surfaces further includes code to create a plurality of 2-D parametric surfaces that are curved 2-D parametric surfaces having no thickness.

In a further example, the code to enable the processor to create one or more 2-D parametric surfaces further includes code to create a plurality of 2-D parametric surfaces that are defined surfaces having no thickness.

In a further example, the computer program product further includes: code to release a linkage between at least two of the at least two of the plurality of 2-D parametric surfaces.

According to a fourth set of examples of the invention, a system to image at least one multi-dimensional data volume is provided, for visualization and interpretation of features selected by a user, where the at least one multi-dimensional data volume is defined by one or more attributes and information leading to the placement of the attributes in a spatial zone, the system including: means for creating one or more 2-D parametric surfaces where each 2-D parametric surface is derived from the at least one data volume; means for drawing at least a portion of each 2-D parametric surface for display to a user; means for linking at least two of the plurality of 2-D parametric surfaces to each other; means for performing an operation on the linked at least two of the plurality of 2-D parametric surfaces while maintaining the relative orientation of the at least two of the plurality of 2-D parametric surfaces with respect to each other; and means for repeating the drawing of at least a portion of each 2-D parametric surface for display to a user after occurrence of an operation on the linked at least two of the plurality of 2-D parametric surfaces. In at least one example, the means for creating one or more 2-D parametric surfaces includes programming code, optionally including scene-graph node(s), that operates on one or more data volumes to derive one or more 2D parametric surfaces that are loaded as planes or surfaces; the means for drawing at least a portion of each 2-D parametric surface includes programming code and data structure(s) or matrices, optionally including scene-graph node(s), that perform a transformation on the data; the means for linking at least two of the plurality of 2-D parametric surfaces to each other includes programming code, optionally including scene-graph node(s), to operate one or more user interfaces such as action handles, a user pull-down menu, a user keyboard, a user interface that allows a user to select the two or more planes, or control signal(s) from a computer program that signals or commands programming code to associate two or more planes with each other; the means for performing an operation on the linked at least two of the plurality of 2-D parametric surfaces includes programming code, optionally including scene-graph node(s), that receive and process signals to update the display matrices and data matrices, using the operation information to transform the plane formation; and the means for repeating the drawing of at least a portion of each 2-D parametric surface includes programming code, optionally including scene-graph node(s), that activate programming code that redisplays the planes based on the transformed matrices, the activation based on receipt of an update signal and/or a periodically generated signal to update.

In a further example, the means for performing an operation is operable to perform an operation selected from a group of operations comprising: translation, rotation, and scaling.

In a further example, the system further includes: means for creating a first set of control points on at least one of the plurality of 2-D parametric surfaces; means for creating a second set of control points on at least one of the plurality of 2-D parametric surfaces; and means for deriving a surface from the first set of control points and the second set of control points. In at least one example, the means for creating a first set of control points and the means for creating a second set of control points include programming code interfaced with user-interface code, optionally including scene-graph node(s), for creating control points by activation through a user-interface, such as a keyboard command or a drop down menu or a clickable button, whereby further clicks from a mouse, for example, captures spatial locations on one or more of the displayed planes. In at least one example, the means for deriving a surface includes programming code to: read the control points, apply a surface fitting function using the control points, and output the resultant surface derived from the fitting function.

In a further example, the operation performing means further includes: means for placing at least one of the plurality of 2-D parametric surfaces so as to reduce the obliqueness of the placed at least one of the plurality of 2-D parametric surfaces with respect to the apparent plane of a feature. In at least one example, the means for placing include programming code that places at least one of the plurality of 2-D parametric surfaces in a position relative to the apparent plane of the feature.

In a further example, the data volume includes at least two attributes and where at least a first 2-D parametric surface of the plurality of 2-D parametric surfaces is derived from a first attribute of the data volume and at least a second 2-D parametric surface of the plurality of 2-D parametric surfaces is derived from a second attribute of the data volume.

In a further example, at least a first 2-D parametric surface of the plurality of 2-D parametric surfaces is derived from an attribute of a first data volume and at least a second 2-D parametric surface of the plurality of 2-D parametric surfaces is derived from an attribute of a second data volume.

In a further example, the system further includes means for restraining computations within a multidimensional area of interest.

In a further example, the 2-D parametric surfaces consist essentially of planar surfaces having no thickness.

In a further example, the 2-D parametric surfaces consist essentially of curved 2-D parametric surfaces having no thickness.

In a further example, the 2-D parametric surfaces consist essentially of defined surfaces having no thickness.

In a further example, the combination of the operation performing means and the drawing repeating means is accomplished in less than one-tenth of a second.

In a further example, the at least one multi-dimensional data volume includes geoscientific data.

In a further example, the at least one multi-dimensional data volume includes petroleum reservoir data.

In a further example, the at least one multi-dimensional data volume includes 3D seismic data, further including at least one attribute. In a further example, at least one attribute is seismic amplitude.

In a further example, the at least one multi-dimensional data volume includes at least one attribute.

In a further example, the linked at least two of the plurality of 2-D parametric surfaces form an open surface.

In a further example, the linkage of the at least two of the plurality of 2-D parametric surfaces is releasable.

According to a fifth set of examples of the invention, a graphical display of geoscientific data is provided, the display including: a multidimensional volume having attributes thereon; and at least two linked surfaces positioned in the volume. The at least two surfaces include: a first surface movably linked to a second surface, where the first and second surfaces are translatable within the volume and where the first and second surfaces are rotatable within the volume.

In a further example, the display further includes a handle on at least one surface.

In a further example, the first and second surfaces are scalable within the volume.

In a further example, the display further includes means for creating a first set of control points on at least one of the at least two surfaces; means for creating a second set of control points on at least one of the at least two surfaces; and means for deriving a resultant surface from the first set of control points and the second set of control points. In at least one example, the means for creating a first set of control points and the means for creating a second set of control points include programming code interfaced with user-interface code, optionally including scene-graph node(s), for creating control points by activation through a user-interface, such as a keyboard command or a drop down menu or a clickable button, whereby further clicks from a mouse, for example, captures spatial locations on one or more of the displayed planes. In at least one example, the means for deriving a resultant surface includes programming code to: read the control points, apply a surface fitting function using the control points, and output the resultant surface derived from the fitting function.

In a further example, the first and second surfaces are rotatable for placement of the at least two surfaces so as to change the obliqueness of at least one of the at least two surfaces with respect to the apparent plane of a feature.

In a further example, the display further includes means for restraining computations within a multidimensional area of interest.

In a further example, the display is redisplayable in less than one-tenth of a second.

In a further example, at least one of the attributes of the data volume is seismic amplitude.

In a further example, the at least two linked surfaces form an open plane formation.

In a further example, the first surface is releasably linked to the second surface.

### BRIEF DESCRIPTION OF THE SEVERAL DRAWINGS

FIG. 1 is a 3-D perspective view of a single plane extracted from a data volume and displayed on a graphics-enabled computing device.

FIG. 2 is a 3-D perspective view of two planes extracted from a data volume and displayed on a graphics-enabled computing device.

FIG. 3 is a 3-D perspective view of three planes extracted from a data volume and displayed on a graphics-enabled computing device.

FIG. 4 is a 3-D perspective view of movement of the planes to a different location in the 3-D data volume.

FIG. 5 is a 3-D perspective view of changing the displayed size of one of the planes in the 3-D data volume.

FIG. 6 is a 3-D perspective view of rotation of the planes in the 3-D data volume.

FIG. 7 is a functional block diagram showing an example method for using the present invention.

FIG. 8 is a scene-graph node chart showing an example implementation of the present invention.

FIG. 9 is a flowchart showing an example method for executing the present invention using a scene-graph.

FIG. 10 is a flowchart showing an example method for executing the present invention using a scene-graph.

### DETAILED DESCRIPTION OF EXAMPLES OF THE INVENTION

In some examples of the invention, 2-D parametric surfaces consist essentially of planar slices extracted or derived, thereby created, from a data volume. Alternatively, 2-D parametric surfaces consist essentially of surfaces having shape in two or three dimensions, while not having thickness of the surface. In either case, the 2-D parametric surfaces serve as visualization surfaces. Selected attribute values from a selected data volume are displayed upon these parametric surfaces by projecting the attribute values onto the parametric surfaces where the parametric surfaces intersect the selected data volume. In some examples, multiple attribute values from one or more data volumes are projected. In further examples, differing attributes or attribute sets are projected onto different parametric surfaces. In a further example, two or more 2-D parametric surfaces are linked for purposes of translation or rotation, in unison, within the data volume or data volumes. Such linking and motion provides enhanced display of various types of data. For example, a user moving through a seismic data volume will detect fault structures that would not be perceived with static planar slices.

The present invention is implemented in many examples with graphics enabled computational devices. In many such examples, software is used to interface with the user, interface with the data volumes, and produce graphical images for the user to view and/or interpret and/or analyze.

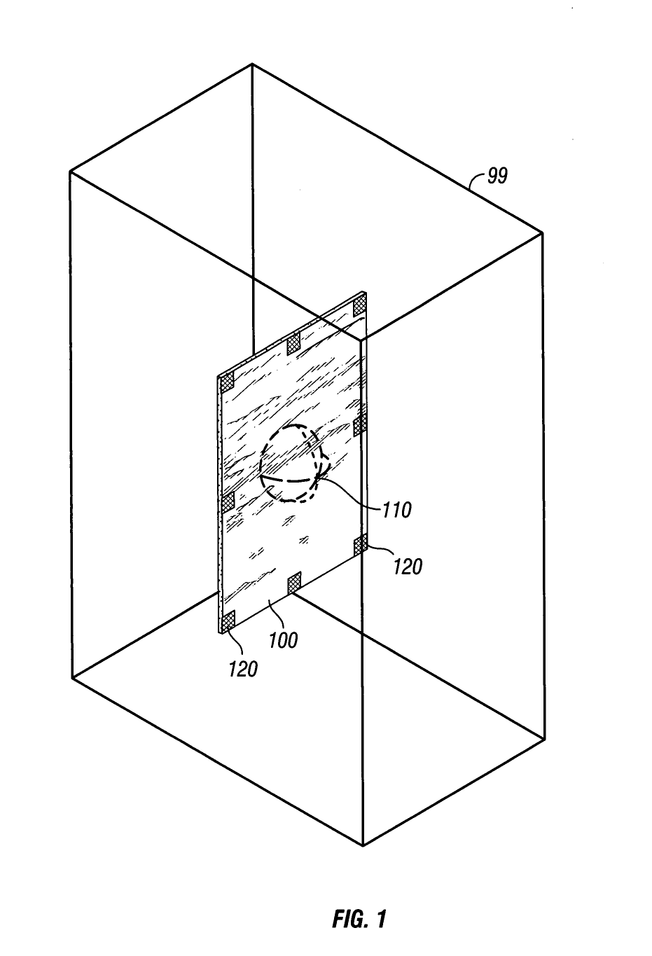

FIG. 1 illustrates a typical example of a graphics enabled computational device displaying a planar slice from a data volume. FIG. 1 illustrates a 3-D perspective view of a single plane created by extraction of data volume values from a data volume and displayed on a graphics-enabled computing device. This view represents an example of a view that will be, in at least one example, seen by a user on a computer graphics display. A first plane 100 is contained within a wire frame 99. Wire frame 99 is illustrated conceptually by the wireframe box for the purpose of illustrating relative orientation of first plane 100 on the display. In practice, wire frame 99 will or will not be shown. First plane 100 represents a 2-D parametric surface derived from a multi-dimensional data volume. In this example, first plane 100 is a two-dimensional plane surface having no thickness and limited aerial extent. Alternatively, 2-D parametric surfaces consist essentially of surfaces having shape in two or three dimensions, while not requiring thickness of the surface. In such examples, a 2-D parametric surface is also defined as the expression of a surface such that no more than two dimensions are required in order to express the surface. In this example, first plane 100 represents a vertically oriented slice from a data volume, such as geoscientific data (used in the context of geologic exploration or development of petroleum reservoirs). In this example, the vertical slice is defined by holding one of the coordinate axes to a constant value, regardless of the value of the other two coordinate axes, thus representing the vertical slice, the surface, as a 2-D parametric surface. In other examples, the 2-D parametric surface represents a curved 2-D parametric surface. The 2-D parametric surface does not contain volume information, as the 2-D parametric surface is dimensionless in the direction normal to the surface of the 2-D parametric surface. In many examples, the data values of the 2-D parametric surface are derived (for example, by interpolation) from one or more data values contained in the data volume(s) and the data values of the 2-D parametric surface do not represent any particular volume of data, as would a voxel or, in some cases, a pixel of data. First plane 100 displays a plane of attribute values, such as seismic amplitude, that occurs at the spatial location of first plane 100. The actual data volume(s) and attribute(s) used will depend on the field of use.

A rotation handle 110 is positioned on plane 100. A rotation handle may also be called a gyro handle. Rotation handle 110 provides an example of a user interface to computer programming code that controls requests to perform operations on first plane 100, such as rotation of the plane within wire frame 99. Action handles 120 provide an example of an additional user interface to computer programming code that controls requests to perform operations on first plane 100, such as selection of the plane, movement of the position of the plane, and scaling of the size of the plane.

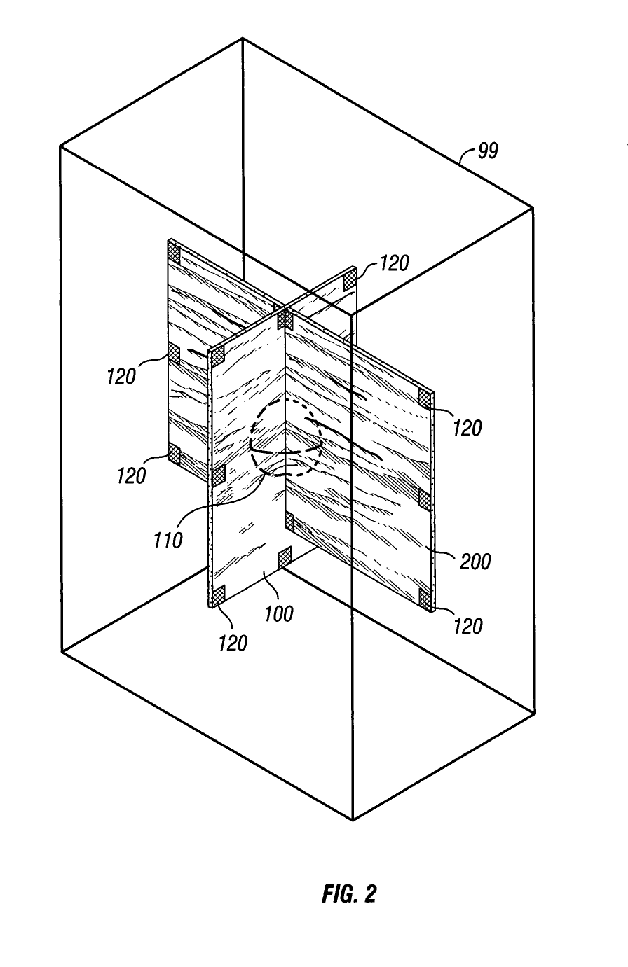

FIG. 2 illustrates a 3-D perspective view of two planes created by extraction or otherwise derived from a data volume and displayed on a graphics-enabled computing device. Second plane 200 is another 2-D parametric surface providing, in this example, a second vertically oriented slice from a data volume. Second plane 200 displays a plane of attribute values that occurs at the spatial location of second plane 200. In practice, second plane 200 will display the same attribute as is shown by first plane 100. In an alternate example, second plane 200 will display an alternate attribute from the data volume. In a further alternate example, second plane 200 will display an alternate attribute from an alternate data volume.

In this example, rotation handle 110 is shown positioned on first plane 100 and second plane 200, approximately centered at the intersection of the two planes. Rotation handle 110 will be, in at least one example, positioned elsewhere in other examples. As will be, in at least one example, further discussed, below, rotation handle 110 serves as a user interface to computer programming code that controls requests to perform operations on both first plane 100 and second plane 200 in unison, such as rotation of the combined planes within wire frame 99. The action handles 120 that are located on second plane 200 provide an example of an additional user interface to computer programming code that controls requests to perform operations on second plane 200, such as selection of the plane, movement of the position of the plane, and scaling of the size of the plane.

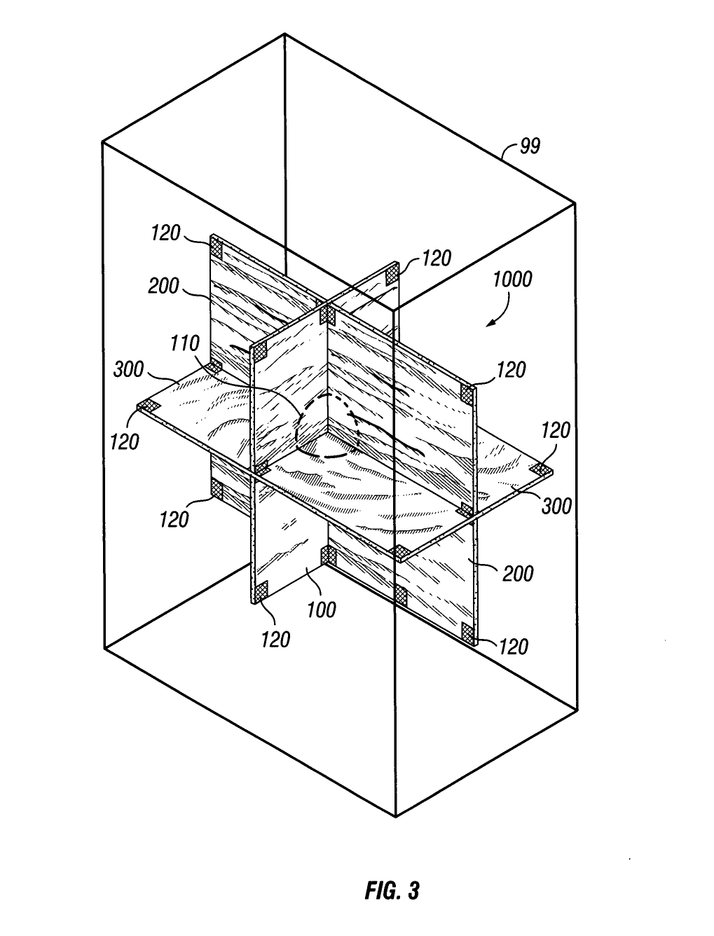

FIG. 3 illustrates a 3-D perspective view of three planes created by extraction or otherwise derived from a data volume and displayed on a graphics-enabled computing device. In the present example, the three planes are located and oriented in a particular location 1000 within the data volume. Third plane 300 is another 2-D parametric surface providing, in this example, a horizontally oriented slice from a geoscientific data volume. Third plane 300 displays a plane of attribute values, such as seismic amplitude, that occurs at the spatial location of third plane 300. In this example, third plane 300 displays the same geoscientific attribute as is shown by either first plane 100 or second plane 200. In an alternate example, third plane 300 will display an alternate attribute from the geoscientific data volume. In a further alternate example, third plane 300 will display an attribute from an alternate geoscientific data volume. In various examples, the plurality of planes form an open surface, as shown in FIG. 2 and FIG. 3.

In this example, rotation handle 110 is shown positioned approximately centered at the intersection of the three planes. Rotation handle 110 will be positioned elsewhere in other examples. As before, rotation handle 110 serves as a user interface to computer programming code that controls requests to perform operations on the three planes in unison, such as rotation of the combined planes within wire frame 99. The action handles 120 that are located on third plane 300 provide an additional user interface to computer programming code that controls requests to perform operations on third plane 300, such as selection of the plane, movement of the position of the plane, and scaling of the size of the plane.

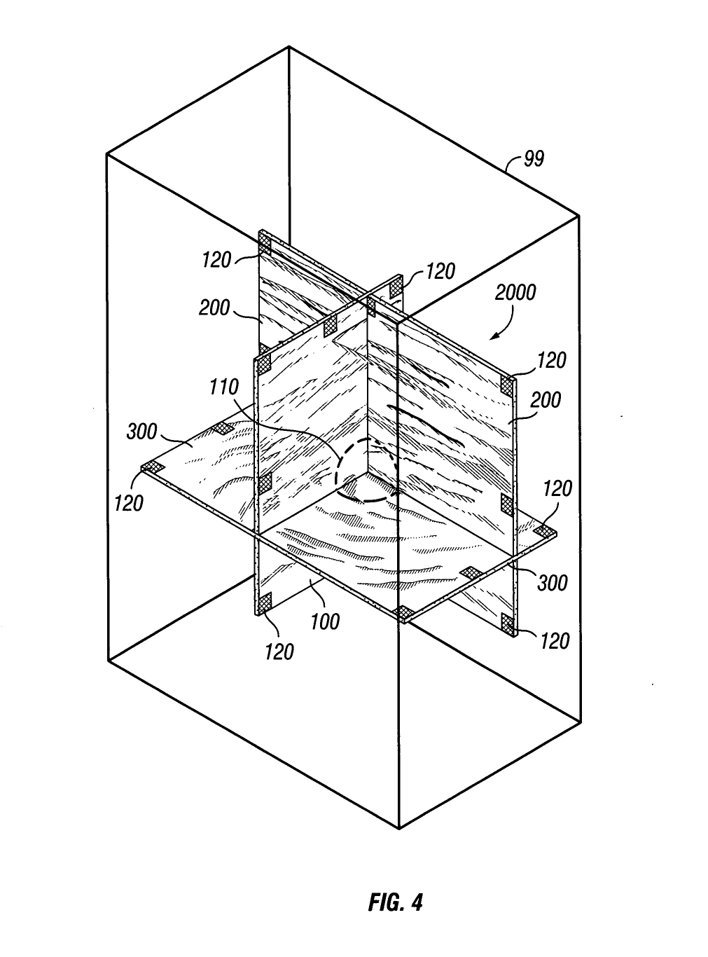

FIG. 4 illustrates a 3-D perspective view of movement of the planes with respect to each other in the 3-D data volume. In FIG. 3, the three planes are located and oriented in a particular location 1000 within the data volume. In FIG. 4, the three planes have moved, plane 200 has moved further back and plane 300 has moved further down to location 2000. In at least one example, the user performs this operation by clicking, with a mouse or other suitable user-interfacing method or device, on action handle 120 of the respective plane (200 or 300) and dragging to the desired new location. The dragging direction is approximately perpendicular to the surface of the plane, which will be, in at least one example, interpreted as a request for performing a translation, or movement of the plane, operation. Upon linking of one or more planes 100, 200, 300, the linked planes are moveable in the 3-D data volume while maintaining the relative orientation of the linked planes with respect to each other. The linked planes are collectively called a plane formation. To move a plane independent of the other linked planes, that plane is unlinked and moved, or, in the alternative, moved prior to linking to another plane. In various examples, the linkage of one plane to another is releasable; allowing repeated positioning of a plane to achieve desired relative orientations amongst the planes and orientation of the linked planes relative to the data volume.

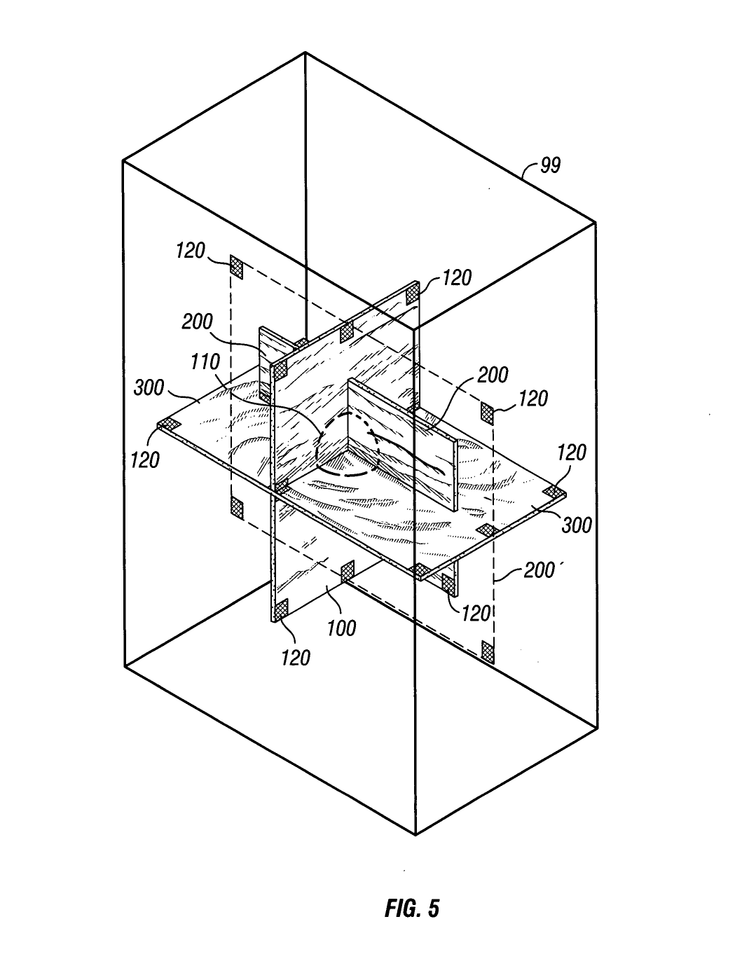

FIG. 5 illustrates an example of changing the displayed size of one of the planes in the 3-D data volume. There, plane 200 has been resized or scaled to a new extent, illustrated by outlining the former extent 200′ of plane 200. In at least one example, the user performs this operation by clicking, with a mouse or other suitable user-interfacing device, on action handle 120 of plane 200 (while in its former extent 200′) and dragging to the desired new extent. The dragging direction is approximately parallel to the surface of the plane, which will be, in at least one example, interpreted as a request for performing a scaling or resizing operation. Upon linking of one or more planes 100, 200, 300, the linked planes are scaleable in the 3-D data volume while maintaining the relative orientation of the linked planes with respect to each other. To scale a plane independent of the other linked planes, that plane is unlinked and scaled, or, in the alternative, scaled prior to linking to another plane.

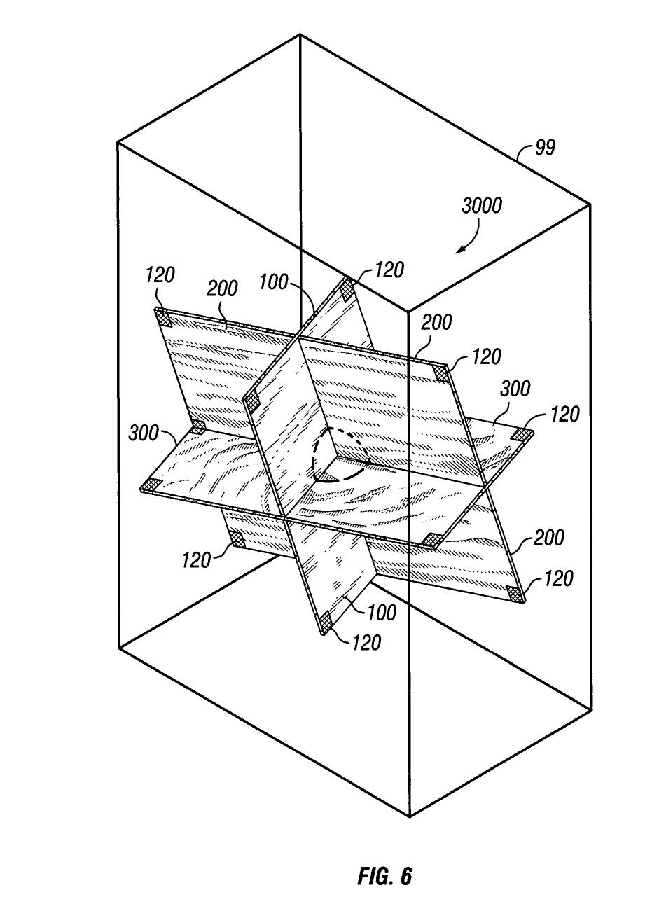

FIG. 6 illustrates an example of rotation of the linked planes in the 3-D data volume. The three planes are located and oriented in a particular location 3000 within the data volume. The three planes have rotated from their original location 1000 seen in FIG. 3; plane 200 has tipped forward and the left side of plane 300 has tilted downwards. The user performs this operation in many examples by clicking, with a mouse or other suitable user-interfacing device or method, on rotation handle 110 and dragging to achieve the desired rotation. The linked planes are rotated in the 3-D data volume while maintaining the relative orientation of the linked planes with respect to each other. To rotate a plane independent of the other linked planes, that plane is unlinked and rotated, or, in the alternative, rotated prior to linking.

In at least one aspect of the present invention, a feature in a data volume will be, in at least one example, identified on the parametric surfaces that represent the data volume. The visibility of some features depends greatly on the angle at which the feature is viewed. A steep or faulted structure, for example, is most visible in its “dip” direction versus its perpendicular “strike” direction. The dip or strike direction of a feature may not be aligned to the axes of a data volume and furthermore may change along the lateral extent of the feature. The translation, rotation, and/or scaling of the planes so as to align the dip and strike viewing perspectives enables interpretation and/or tracking of the feature. Operating on the planes, placing at least one plane so as to reduce the obliqueness of that plane with respect to the apparent plane of the feature aids in the visualization. For example, in a situation in which two planes are oriented perpendicular to one another, placing one of the planes generally parallel to the strike of the feature will cause the second of the planes to be oriented in the dip direction of the feature. Repeated re-placements or re-orientations of the planes allow for enhanced visualization of the feature and increased ease in identification, tracking, and/or interpretation of the feature.

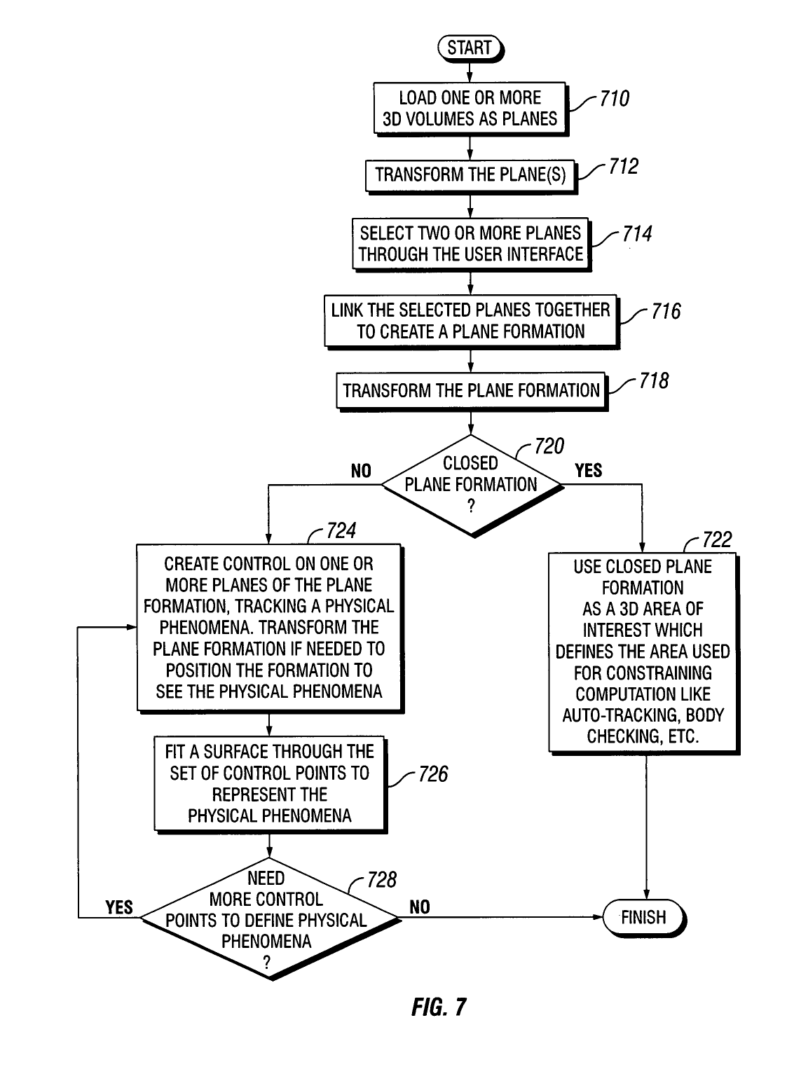

FIG. 7 is a functional block diagram showing an example method for using the present invention and associated means for performing the method. In Step 710, 2-D parametric surfaces are created from one or more data volumes. In the example of FIG. 7, the means for creating, for example, includes programming code that operates on one or more 3D data volumes to derive one or more 2D parametric surfaces that are loaded as planes.

Means are then provided for drawing an image of the planes, typically comprising programming code and data matrices that perform a transformation on the data, Step 712, such that an image of the planes is displayed on a computer graphics device. Means are then provided to link two or more planes with respect to each other, typically comprising one or more user interfaces such as action handles 120, a user pull-down menu, user keyboard, allowing a user to select the two or more planes through a user interface, or control signal from a computer program that signals or commands programming code to associate two or more planes with each other. This is exemplified by selecting two or more planes through a user interface at Step 714. Upon receipt of the signal or command to associate, programming code then flags the selected planes be linked together to create a plane formation, at Step 716. With the plane formation now established by the link, operations are performed on the linked planes. Means for operating on the linked planes include, for example, programming code that receives signals to update the display and the data matrices that store rotation information received earlier from rotation handle 110 of FIGS. 1-6. The programming code uses the matrix information to transform the plane formation, at Step 718. Once the plane formation is transformed, it will be, in at least one example, redisplayed by providing means for repeating the drawing of an image of the planes. An example of an acceptable means for repeating includes programming code to activate programming code that redisplays the planes based on the transformed matrices, the activation based on receipt of an update signal and/or a periodically generated signal to update. In a preferred example, the operations on the linked planes and their redrawing are performed by the computer code in less than one tenth of one second, providing the appearance of continuous movement of, and control over the plane formation.

In some examples, the user performs identification and/or tracking operations on the planes, (e.g. interpretation, auto-tracking, body checking, etc). In some situations it will be, in at least one example, desirable to restrict the spatial extent of the identification or tracking operations. In such case, a limited portion, or “closed portion” of the plane formation is defined. This is accomplished in many examples by selecting a 3-D area of interest within the data volume. In a specific example, defining points on the planes are identified. In Step 720, a check is made to determine whether to use the plane formation as a 3-D area of interest to define the area to be used for constraining computations associated with identification or tracking operations, at Step 722. The check will be, in at least one example, performed by using programming code to detect a user-selected flag or the presence of a table of identified defining points. Code will use the table of identified defining points to restrain further computations to an area of interest, thereby providing a means for restraining computations.

If the plane formation is not to be used to define an area for restraining computations, means for creating control points are provided, including programming code in communication with user-interface code, typically creating control points on at least one of the planes of the plane formation, at Step 724. Examples for creating control points include activation through a user-interface, such as a keyboard command or a drop down menu or a clickable button, whereby further clicks from a mouse captures spatial locations on one or more of the displayed planes. The spatial locations are further processed by transformation into base coordinates and stored in a data structure or table for use in defining an area of interest. Control points are used in many examples to identify the spatial location of some feature or physical phenomena that is observed from the display of the attribute from the data volume that is presented by the plane. As discussed before, in many instances, an operation is performed on the plane formation (for example, a rotation to place the plane formation in an orientation for better viewing of the desired feature). Additional control points are created in further examples, based on the other planes, to further identify the spatial location of the feature. Means for deriving a surface are provided, typically, so as to fit a surface through the control points, thereby providing an interpretation of the spatial characteristics of the feature at Step 726. An example of such means includes providing programming code to read the control points, applying a surface fitting function using the control points, and then outputting the resultant surface derived from the fitting function. These steps will be, in at least one example, repeated to create additional control points to further define or refine the derived/resultant surface at Step 728. Various loops and alternatives are available to define control points. For example, the formation of planes will be, in at least one example, reassembled differently and/or the attributes and data volumes displayed will be, in at least one example, changed. By repeating the process, different features are rapidly interpreted.

In a further example, a system is provided for imaging a multi-dimensional data volume for visualization and interpretation of features selected by a user, where the multi-dimensional data volume is defined by one or more attributes well as information leading to the spatial placement of the attributes in a spatial zone. In at least one example, such a system is implemented as a program storage device readable by a machine, tangibly embodying a program of instructions executable by the machine to perform steps for visualizing a multi-dimensional data volume. In a further example, a computer program product is provided in the form of a computer useable medium having computer program logic recorded thereon for enabling a processor in a computer system to image a multi-dimensional data volume for visualization and interpretation of features selected by a user, where the multi-dimensional data volume is defined by one or more attributes and information leading to the placement of the attributes in a spatial zone. In various examples, the computer program logic includes code to enable a processor in a computer system to image a multi-dimensional data volume for visualization and interpretation of features selected by a user. These and other implementations are described in following examples.

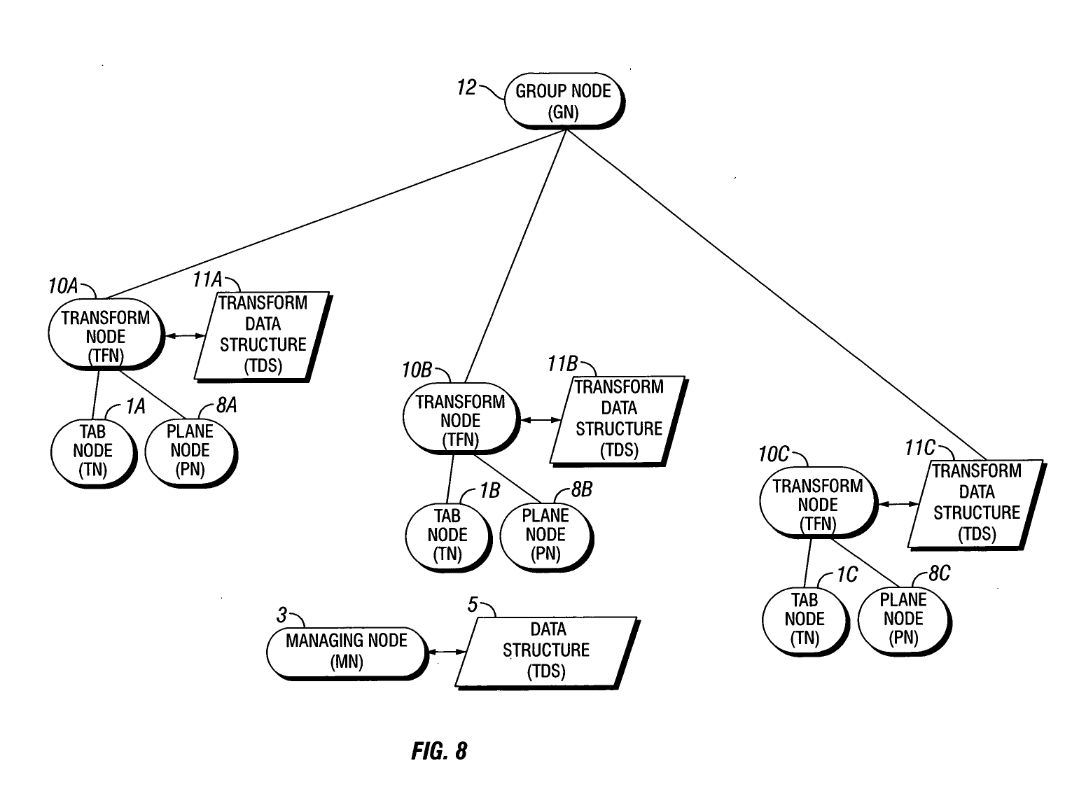

FIG. 8 is a scene-graph node chart showing an example of the present invention. A scene-graph is a programming model and method for creation of program execution code. Scene-graphs will be, in at least one example, used for programming with object-oriented 3-D toolkits, such as the OpenInventor brand tool kit supported by Silicon Graphics, Inc. of Sunnyvale, Calif. One specific example of means for drawing an image of a plane is illustrated by FIG. 8. Here, each of Plane Node (PN) 8A, 8B, and 8C execute programming code to manage and draw a particular plane derived from a multi-dimensional data volume. Plane Node 8A, in at least one example, represents the programming control for displaying first plane 100 of FIG. 3. In like manner, Plane Node 8B represents the programming control for displaying second plane 200 and Plane Node 8C represents the programming control for displaying third plane 300.

In the example of FIG. 8, each of Tab Node (TN) 1A, 1B, 1C is associated with each respective plane and executes programming code to provide a user interface for commanding operations to be performed on their respective planes. A more generic form of a tab node, such as a manipulation node or a dragger node, is used in other examples. Tab Node (TN) 8A, for example, represents the programming control for implementation of action handles 120 of first plane 100 of FIG. 3 in some situations. Tab Nodes (TN) 1A, 1B, 1C and Plane Node (PN) 8A, 8B, and 8C communicate with their respective Transform Nodes (TFN) 10A, 10B, 10C. Transform Nodes (TFN) 10A, 10B, 10C execute programming code to operate on the planes by providing transformation functions and information, such as transformation matrices, necessary to convert across the coordinate systems used for storage of the data volume and planes to the coordinate system used for final display. Transform Data Structure (TDS) 11A, 11B, 11C stores the matrix transformation information for each of their respective transform nodes. Group Node (GN) 12 executes programming code to launch and manage the nodes associated with one or more planes. In one example, a means for creating a plane comprises Group Node (GN) 12 having capability to launch a Transform Node (TFN) and a Plane Node (PN) to generate and manage the newly created plane. Group Node (GN) 12 communicates commands to one or more of Transform Data Structures (TDS) 11A, 11B, 11C to achieve management and control over their respective Plane Nodes (PN) 8A, 8B, and 8C. While the preceding example presents three planes with their respective nodes, in further examples Group Node (GN) 12 launches and/or manages any number of planes and their respective nodes. In one example, a means for repeated drawing or redisplay of the planes comprises Group Node (GN) 12 in communication with Transform Nodes (TFN) 10A, 10B, 10C to send commands to update or redraw the display to each of the respective Plane Nodes (PN) 8A, 8B, 8C.

An example of a specific means for linking two or more planes comprises Managing Node (MN) 3, which executes programming code to store plane selections and their respective linkages to other planes. Data Structure (DS) 5 stores the plane selections and their respective linkages to other planes, as provided by Managing Node (MN) 3.

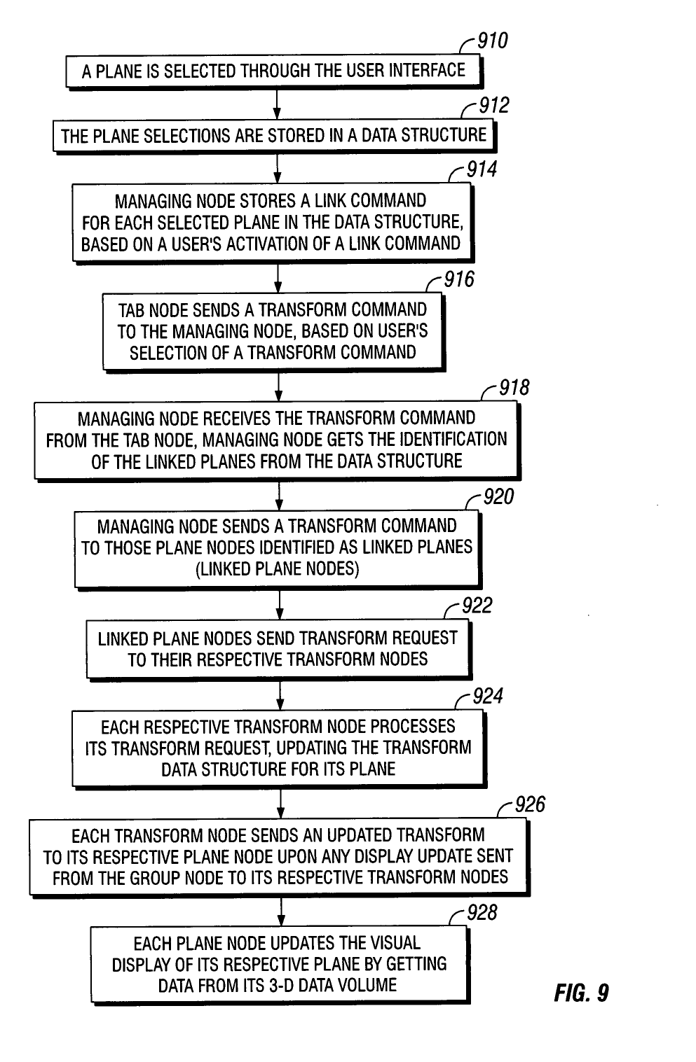

FIG. 9 is a flowchart showing an example method of the present invention using a scene-graph-programming model. One or more planes are selected through a user interface, at Step 910. In the FIG. 9 example, the selection is made through a keyboard input, pull down menu, or by the Tab Node (TN) 1A, 1B, or 1C. The plane selections are stored in a data structure, at Step 912. The respective Tab Nodes (TN) 1A, 1B, or 1C communicate the selection operation to the Managing Node (MN) 3. The managing node stores the selection as a link command in the data structure, at Step 914. Managing Node (MN) 3 transfers the link command information to Data Structure (DS) 5.

Upon further action by the user, to perform an operation on a plane, the user interface sends an operation command to the managing node, at Step 916. Tab Node (TN) 1A, 1B, or 1C communicates a transform command to Managing Node (MN) 3. The managing node receives the operation command and retrieves the link command information from the data structure, at Step 918. Managing Node (MN) 3 receives the transform command from Tab Node (TN) 1A, 1B, or 1C and retrieves the link command information from Data Structure (DS) 5. The managing node then sends the operation command to those plane nodes that are identified as linked, based on the link command information from the data structure, at Step 920. In the present example, Managing Node (MN) 3 sends the transformation command to one or more of Plane Nodes (PN) 8A, 8B, or 8C, to those which are linked to each other. Each of the linked plane nodes sends an operation command to their respective transform node, at Step 922. Each of Plane Nodes (PN) 8A, 8B, and 8C, presuming all are linked to one another, communicates a transformation command to their respective Transform Nodes (TFN) 10A, 10B, 10C.

Each respective transform node processes their respective operation command, updating their respective transformation data structure, at Step 924. Each of Transform Nodes (TFN) 10A, 10B, 10C performs the matrix transformation calculation and stores the result in their respective Transform Data Structure (TDS) 11A, 11B, 11C. Upon any display update, each respective transform node then sends its respective transform to its respective plane node for display processing, at Step 926. Group Node (GN) 12 further communicates commands to update or redraw the display to each of the respective Transform Nodes (TFN) 10A, 10B, 10C. Each of Transform Nodes (TFN) 10A, 10B, 10C then communicates a command to redisplay along with their respective transform information to both their respective Plane Nodes (PN) 8A, 8B, 8C and Tab Nodes (TN) 1A, 1B, 1C. Plane Nodes (PN) 8A, 8B, 8C access the appropriate attribute data from one or more multi-dimensional data volumes to produce the display. Referring to FIGS. 3-6, planes 100, 200, 300 along with their respective action handles 120 are redrawn or redisplayed with the transformation that is based on the operation command performed.

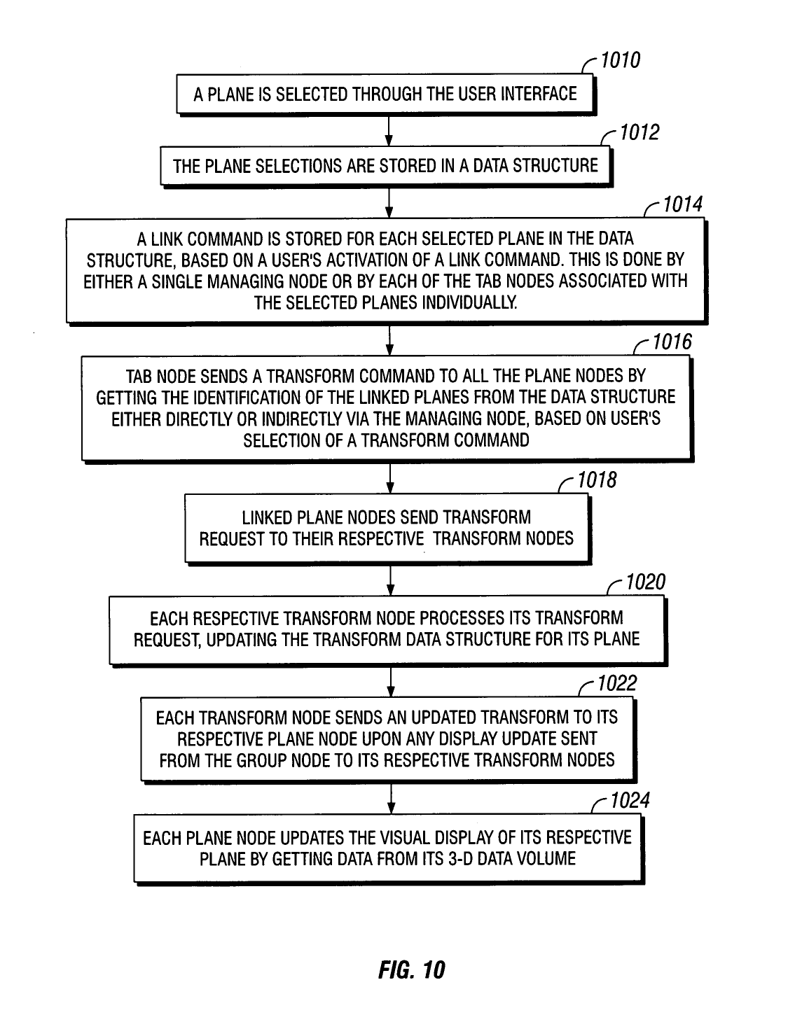

FIG. 10 is a flowchart showing another example of a method for executing the present invention using a scene-graph. One or more planes are selected through a user interface, at Step 1010. In various examples, the selection is made through a keyboard input, pull down menu, or by the Tab Node (TN) 1A, 1B, or 1C. The plane selections are stored in a data structure, at Step 1012. Upon execution by a processor, the programming code of the user interface stores the selection as a link command in the data structure, at Step 1014. The respective Tab Nodes (TN) 1A, 1B, or 1C transfers the link command information to Data Structure (DS) 5.

Upon further action by the user, to perform an operation on a plane, the user interface sends an operation command to all the plane nodes, which are linked according to the data structure, at Step 1016. A Tab Node (TN) 1A, 1B, or 1C retrieves the link command information from Data Structure (DS) 5 and communicates a transform command to each Plane Node (PN) 8A, 8B, and/or 8C that is linked. The linked plane nodes receive the operation command, sending the operation command to their respective transformation data structure, at Step 1018. Each Plane Node (PN) 8A, 8B, and/or 8C that is linked receives the transform command from Tab Node (TN) 1A, 1B, or 1C and sends the transform command to their respective Transform Nodes (TFN) 10A, 10B, 10C.

Each respective transform node processes their respective operation command, updating their respective transformation data structure, at Step 1020. Each of Transform Nodes (TFN) 10A, 10B, 10C performs the matrix transformation calculation and stores the result in their respective Transform Data Structure (TDS) 11A, 11B, 11C. Upon any display update, each respective transform node then sends its respective transform to its respective plane node for display processing, at Step 1022. Group Node (GN) 12 further communicates commands to update or redraw the display to each of the respective Transform Nodes (TFN) 10A, 10B, 10C. Each of Transform Nodes (TFN) 10A, 10B, 10C then communicates a command to redisplay along with their respective transform information to both their respective Plane Nodes (PN) 8A, 8B, 8C and Tab Nodes (TN) 1A, 1B, 1C. Each plane node updates the visual display of its respective plane, based on the attribute data of the multi-dimensional data volume, Step 1024. Plane Nodes (PN) 8A, 8B, 8C access the appropriate attribute data from one or more multi-dimensional data volumes to produce the display. Referring to FIGS. 3-6, planes 100, 200, 300 along with their respective action handles 120 are redrawn or redisplayed with the transformation based on the operation command performed.

The foregoing description is presented for purposes of illustration and description, and is not intended to limit the invention to the forms disclosed herein. Consequently, variations and modifications commensurate with the above teachings and the teaching of the relevant art are within the spirit of the invention. Such variations will readily suggest themselves to those skilled in the relevant structural or mechanical art. Further, the embodiments described are also intended to explain the best mode for carrying out the invention, and to enable others skilled in the art to utilize the invention and such or other embodiments and with various modifications required by the particular applications or uses of the invention. It is intended that the appended claims be construed to include alternative embodiments to the extent that is permitted by prior art.

What is claimed is:

1. A program storage device readable by a machine, tangibly embodying a program of instructions executable by the machine to perform steps of displaying at least one multi-dimensional data volume, the steps comprising: (a) creating a plurality of 2-D parametric surfaces, wherein each 2-D parametric surface is derived from the at least one data volume; (b) drawing at least a portion of each 2-D parametric surface for display to a user; (c) linking at least two of the plurality of 2-D parametric surfaces to each other; (d) performing an operation on the linked at least two of the plurality of 2-D parametric surfaces while maintaining the relative orientation of the at least two of the plurality of 2-D parametric surfaces with respect to each other; and (e) repeating drawing step (b).

2. The program storage device of claim 1, wherein said performing an operation step comprises an operation selected from a group comprising: translation, rotation, and scaling.

3. The program storage device of claim 1, wherein said steps further comprise the steps of: creating a first set of control points on at least one of said plurality of 2-D parametric surfaces; repeating step (d); repeating step (e); creating a second set of control points on at least one of said plurality of 2-D parametric surfaces; and deriving a surface from said first set of control points and said second set of control points.

4. The program storage device of claim 1, wherein said steps further comprise the step of: identifying a feature on at least one of said plurality of 2-D parametric surfaces; and wherein said performing an operation step is operable to place at least one of said plurality of 2-D parametric surfaces in a position so as to change the obliqueness of the placed at least one of said plurality of 2-D parametric surfaces with respect to the apparent plane of the feature.

5. The program storage device of claim 1, wherein at least a first 2-D parametric surface of said plurality of 2-D parametric surfaces is derived from a first attribute of said data volume and wherein at least a second 2-D parametric surface of said plurality of 2-D parametric surfaces is derived from a second attribute of said data volume.

6. The program storage device of claim 1, wherein at least a first 2-D parametric surface of said plurality of 2-D parametric surfaces is derived from an attribute of a first data volume and wherein at least a second 2-D parametric surface of said plurality of 2-D parametric surfaces is derived from an attribute of a second data volume.

7. The program storage device of claim 1, wherein said steps further comprise defining a multidimensional area of interest, whereby an area for restraining computations is formed.

8. The program storage device of claim 1, wherein said 2-D parametric surfaces consist essentially of planar surfaces having no thickness.

9. The program storage device of claim 1, wherein said 2-D parametric surfaces consist essentially of curved 2-D parametric surfaces having no thickness.

10. The program storage device of claim 1, wherein said linked at least two of the plurality of 2-D parametric surfaces form an open surface.

11. The program storage device of claim 1, wherein said linking at least two of the plurality of 2-D parametric surfaces to each other is releasable.

12. A method for visualization of a multi-dimensional data volume representing a spatial zone for visualization and interpretation of physical parameters of the spatial zone selected by a user, the multi-dimensional volume being defined by one or more attributes and information leading to the placement of the attributes in the spatial zone, the method comprising: (a) creating a plurality of 2-D parametric surfaces, wherein each 2-D parametric surface is derived from the data volume; (b) drawing at least a portion of each 2-D parametric surface for display to a user; (c) linking at least two of the plurality of 2-D parametric surfaces to each other; (d) performing an operation on the linked at least two of the plurality of 2-D parametric surfaces while maintaining the relative orientation of the at least two of the plurality of 2-D parametric surfaces with respect to each other; and (e) repeating drawing step (b).

13. The method of claim 12, wherein said operation comprises an operation selected from a group comprising: translation, rotation, and scaling.

14. The method of claim 12, wherein said method further comprises the steps of: creating a first set of control points on at least one of said plurality of 2-D parametric surfaces; repeating method step (d); repeating method step (e); creating a second set of control points on at least one of said plurality of 2-D parametric surfaces; and fitting a surface from said first set of control points and said second set of control points.

15. The method of claim 12, wherein said method further comprises the steps of: identifying a feature on at least one of said plurality of 2-D parametric surfaces; and wherein said performing operation step comprises placing at least one of said plurality of 2-D parametric surfaces so as to change the obliqueness of the placed at least one of said plurality of 2-D parametric surfaces with respect to the apparent plane of the feature.

16. The method of claim 12, wherein at least a first 2-D parametric surface of said plurality of 2-D parametric surfaces is derived from a first attribute of said data volume and wherein at least a second 2-D parametric surface of said plurality of 2-D parametric surfaces is derived from a second attribute of said data volume.

17. The method of claim 12, wherein at least a first 2-D parametric surface of said plurality of 2-D parametric surfaces is derived from an attribute of a first data volume and at least a second 2-D parametric surface of said plurality of 2-D parametric surfaces is derived from an attribute of a second data volume.

18. The method of claim 12, wherein said method further comprises the step of defining a multidimensional area of interest, whereby an area for restraining computations is formed.

19. The method of claim 12, wherein said step of creating a plurality of 2-D parametric surfaces further comprises the step of creating one or more 2-D parametric surfaces consisting essentially of planar surfaces having no thickness.

20. The method of claim 12, wherein said step of creating a plurality of 2-D parametric surfaces further comprises the step of creating one or more 2-D parametric surfaces consisting essentially of curved 2-D parametric surfaces having no thickness.

21. The method of claim 12, wherein said linked at least two of the plurality of 2-D parametric surfaces form an open surface.

22. The method of claim 12, wherein said linking of said at least two of the plurality of 2-D parametric surfaces is releasable.

23. A computer program product comprising a computer useable medium having computer program logic recorded thereon for enabling a processor in a computer system to image a multi-dimensional data volume for visualization and interpretation of features selected by a user, wherein the multi-dimensional data volume is defined by one or more attributes and information leading to the placement of the attributes in a spatial zone, the computer program logic comprising:
code to enable the processor to create a plurality of 2-D parametric surfaces wherein each 2-D parametric surface is derived from the data volume;
code to enable the processor to draw at least a portion of each 2-D parametric surface for display to a user;
code to enable the processor to link at least two of the plurality of 2-D parametric surfaces to each other;
code to enable the processor to operate on the linked at least two of the plurality of 2-D parametric surfaces while maintaining the relative orientation of the at least two of the plurality of 2-D parametric surfaces with respect to each other; and
code to enable the processor to repeat the drawing of at least a portion of each 2-D parametric surface for display to a user after occurrence of an operation on the linked at least two of the plurality of 2-D parametric surfaces.

24. The computer program product of claim 23, wherein said code to enable the processor to operate on the linked at least two of the plurality of 2-D parametric surfaces comprises code to enable the processor to perform an operation selected from a group of operations comprising: translation, rotation, and scaling.

25. The computer program product of claim 23, further comprising:
code to enable the processor to create a first set of control points on at least one of said plurality of 2-D parametric surfaces;
code to enable the processor to create a second set of control points on at least one of said plurality of 2-D parametric surfaces; and
code to enable the processor to derive a surface from said first set of control points and said second set of control points.

26. The computer program product of claim 23, wherein said code to enable the processor to operate on the linked at least two of the plurality of 2-D parametric surfaces further comprises:
code to enable the processor to place at least one of said plurality of 2-D parametric surfaces so as to change the obliqueness of the placed at least one of said plurality of 2-D parametric surfaces with respect to the apparent plane of a feature.

27. The computer program product of claim 23, wherein said data volume comprises at least two attributes and further comprising code to derive at least a first 2-D parametric surface of said plurality of 2-D parametric surfaces from a first attribute of said data volume and further comprising code to derive at least a second 2-D parametric surface of said plurality of 2-D parametric surfaces from a second attribute of said data volume.

28. The computer program product of claim 23, further comprising code to derive at least a first 2-D parametric surface of said plurality of 2-D parametric surfaces from an attribute of a first data volume and further comprising code to derive at least a second 2-D parametric surface of said plurality of 2-D parametric surfaces from an attribute of a second data volume.

29. The computer program product of claim 23, wherein the computer program logic further comprises code to restrain computations within a multidimensional area of interest.

30. The computer program product of claim 23, wherein said code to enable the processor to create a plurality of 2-D parametric surfaces further comprise code to create one or more 2-D parametric surfaces that consist essentially of planar surfaces having no thickness.

31. The computer program product of claim 23, wherein said code to enable the processor to create a plurality of 2-D parametric surfaces further comprise code to create one or more 2-D parametric surfaces that consist essentially of curved 2-D parametric surfaces having no thickness.

32. The computer program product of claim 23, further comprising code to release a linkage between at least two of said at least two of the plurality of 2-D parametric surfaces.

33. A system to image at least one multi-dimensional data volume for visualization and interpretation of features selected by a user, wherein the at least one multi-dimensional data volume is defined by one or more attributes and information leading to the placement of the attributes in a spatial zone, the system comprising:
means for creating one or more 2-D parametric surfaces wherein each 2-D parametric surface is derived from the at least one data volume;
means for drawing at least a portion of each 2-D parametric surface for display to a user;
means for linking at least two of the plurality of 2-D parametric surfaces to each other;
means for performing an operation on the linked at least two of the plurality of 2-D parametric surfaces while maintaining the relative orientation of the at least two of the plurality of 2-D parametric surfaces with respect to each other; and
means for repeating the drawing of at least a portion of each 2-D parametric surface for display to a user after occurrence of an operation on the linked at least two of the plurality of 2-D parametric surfaces.

34. The system of claim 33, wherein said operation performing means is operable to perform an operation selected from a group of operations comprising: translation, rotation, and scaling.

35. The system of claim 33, further comprising:
means for creating a first set of control points on at least one of said plurality of 2-D parametric surfaces;
means for creating a second set of control points on at least one of said plurality of 2-D parametric surfaces; and
means for deriving a surface from said first set of control points and said second set of control points.

36. The system of claim 33, wherein said operation performing means further comprises:
means for placing at least one of said plurality of 2-D parametric surfaces so as to change the obliqueness of the placed at least one of said plurality of 2-D parametric surfaces with respect to the apparent plane of a feature.

37. The system of claim 33, wherein said data volume comprises at least two attributes and wherein at least a first 2-D parametric surface of said plurality of 2-D parametric surfaces is derived from a first attribute of said data volume and at least a second 2-D parametric surface of said plurality of 2-D parametric surfaces is derived from a second attribute of said data volume.

38. The system of claim 33, wherein at least a first 2-D parametric surface of said plurality of 2-D parametric surfaces is derived from an attribute of a first data volume and wherein at least a second 2-D parametric surface of said plurality of 2-D parametric surfaces is derived from an attribute of a second data volume.

39. The system of claim 33, further comprising means for restraining computations within a multidimensional area of interest.

40. The system of claim 33, wherein said 2-D parametric surfaces consist essentially of planar surfaces having no thickness.

41. The system of claim 33, wherein said 2-D parametric surfaces consist essentially of curved 2-D parametric surfaces having no thickness.

42. The computer program product of claim 33, wherein said linked at least two of the plurality of 2-D parametric surfaces form an open surface.

43. The computer program product of claim 33, wherein said linkage of said at least two of the plurality of 2-D parametric surfaces is releasable.

44. A graphical display of geoscientific data, the display comprising:
a multidimensional volume having attributes thereon;
at least two linked surfaces positioned in the volume;
the at least two surfaces comprising:
a first surface movably linked to a second surface,
wherein the first and second surfaces are translatable within the volume and
wherein the first and second surfaces are rotatable within the volume.

45. A display as in claim 44, further comprising a handle on at least one surface.

46. A display as in claim 44, wherein the first and second surfaces are scalable within the volume.

47. A display as in claim 44, further comprising:
means for creating a first set of control points on at least one of the at least two surfaces;
means for creating a second set of control points on at least one of the at least two surfaces; and
means for deriving a resultant surface from the first set of control points and the second set of control points.

48. A display as in claim 44, wherein the first and second surfaces are rotatable for placement of the at least two surfaces so as to change the obliqueness of at least one of the at least two surfaces with respect to the apparent plane of a feature.

49. The system of claim 44, further comprising means for restraining computations within a multidimensional area of interest.

50. The system of claim 44, wherein at least two linked surfaces form an open plane formation.

51. A display as in claim 44, wherein the first surface is releasably linked to the second surface.
